(19) United States
(12) Patent Application Publication
(10) Pub. No.: US 2010/0002001 A1
(43) Pub. Date: Jan. 7, 2010

(54) SYSTEM FOR REPRESENTING A VIRTUAL ENVIRONMENT

(76) Inventor: Ulrich Jerichow, Gelnhausen (DE)

Correspondence Address: ROBERTS & ROBERTS, LLP;ATTORNEYS AT LAW, P.O. BOX 484, PRINCETON, NJ, 08542-0484, US

(21) Appl. No.: 12/373,357

(22) PCT Filed: Apr. 28, 2007
(86) PCT No.: PCT/EP07/03784

§ 371 Date: Jan. 12, 2009

(30) Foreign Application Priority Data
Jul. 18, 2006 (DE) 20 2006 011 058.5

(51) Int. Cl. G06T 15/20; H04N 13/04; G09G 5/00; A63B 71/00

(52) U.S. Cl. 345/427; 348/51; 345/156; 482/1

(57) ABSTRACT

A system for representing a virtual environment is described, in which the system comprises means which comprise a fitness device, a means for two-dimensional and/or three-dimensional visual representation, at least one acoustic output and/or recording means and means for generating wind, temperature and/or odour.

The invention relates to a system for displaying a virtual environment, which can employed in the fields of wellness, fitness and/or medicine.

In a German Utility Model (DE 20 2004 007 273 U1), a recreational and/or educational device, in particular a wellness system, is described, which presents films by means of a film projector and a film projection area inside closed rooms and which includes motion-, sound-, wind-, odor-, light- and/or other radiation-generating devices and/or sensor devices, connected to one another via a control unit, and the activities and modes of operation of these devices are adapted in time, location and/or intensity to events in the film presentation.

However, no recording or analysis of bodily functions and conditions is done in such systems and similar systems, so it is not possible to monitor the effect or success of their use, either. Moreover, with such systems, neither special fitness or training programs nor medical applications can be performed.

The object of the invention is to make a virtual environment available to the user in which various senses are stimulated, special fitness programs are executed, and bodily functions can be monitored.

This object is attained by a system which comprises fitness equipment, a means for two- and/or three-dimensional visual display, at least one acoustic output and/or recording means, and a means for generating wind, temperature, and/or odor.

In all of this systems technology, substantially more-efficient recreational and experience-oriented training for both intensive and less-intensive recreational sports can be performed.

To that end, it is advantageous that this system includes a means for stimulating the sense of touch and/or a means for varying the composition of the breathing air. In using the system, not only expensive flights for training stops in high mountain regions can be dispensed with, but also the effective time needed to achieving the same training effect in terms of physical conditioning can be shortened, from two hours, for instance, to one hour. In parallel, an up to 10% higher increase in performance is attainable, compared to conventional training.

It is furthermore advantageous that the components are connected to one another and controlled via a computer system, and the computer system includes at least one control computer with a user surface, and computers for image calculation for the right and left eyes are connected to this control computer via a network.

Moreover, external data storage units can be connected to the control computer, such as a DVD or video cassette or disc player. Thus the system can be adapted flexibly, depending on the application.

It is furthermore advantageous that the generated signals are forwarded to a helmet, one on the head of the user, with LCDs for generating the virtual environment (head-mounted display or HMD). Alternatively, the generated signals are used for stereo projection for generating a three-dimensional display on a screen.

In an advantageous further refinement of the system, the control computer is connected to one or more input units having at least six degrees of freedom for determining the position and orientation, and the input units can be equipped selectively with one or more keys.

It is also advantageous that isometric, isotonic and/or elastic input units, for instance, are connected to the control computer, and with the input units, viewing motion detection, body motion detection, head motion detection, and/or position determination can be effected. In a further advantageous feature, with the input units, gestures, facial expressions, and/or speech can be detected.

In an especially advantageous variant embodiment, a head tracker, for instance, is used as the input unit and can also be secured to the helmet, worn on the head of the user, with LCDs for generating the virtual environment (head-mounted display or HMD).

It is also advantageous that the visual display unit reproduces a still picture, a moving or nonmoving object, a computer graphic, and/or two- and/or three-dimensional moving pictures or films. For that purpose, conventional monitors can also be used for the two-dimensional display.

In an advantageous feature, the visual display unit can reproduce an image with a viewing angle of from 0° to 179°, or, for use of the system in the fields of fitness, wellness or medicine, it can also reproduce an image with a viewing angle of 180° or more than 180°, and real moving pictures and/or real still pictures taken beforehand by the user can also be displayed.

For use in the fitness field, it is especially advantageous that as the fitness equipment, a rowing system, bicycle, or treadmill, for instance, is integrated with the system. Thus a combination of physical and psychological stimuli is made possible, and an aroma application or altitude training can be performed in a virtual three-dimensional environment. Thus performance data of the user can be detected and medical variables such as pulse can be recorded. To that end, in a further refinement of the system, by drawing blood, more-precise blood count analyses can be made before, during, and/or after use. For instance, with the aid of a cell analyzer connected to the computer system, preferably a device for flow cytometry, the composition of the blood cells can be determined exactly. It is also possible, by using specific antibodies, preferably coupled with a fluorescent dye, to make an analysis of surface markers on the cells.

It is furthermore advantageous that the acoustic output unit reproduces music instruments, human voices, ambient noises such as animal sounds, wind, rain, waterfalls, thunder, and/or noises of vehicle motors, shots, pumps, explosions, and/or excavation work.

In an advantageous further refinement, wind, temperature, odor, and/or humidity can be adapted to the displayed situation in virtual reality.

It is also advantageous that directions and/or instructions from outside the system can be given to the user via a communications unit. To that end, acoustic or visual directions can be given to the user, for instance by a qualified therapist.

For that purpose, it is advantageous that the user can get in touch with a person outside the system, via a communications unit.

In a further advantageous refinement of the invention, the user can vary the oxygen content within a few seconds from a low value, in the range between 9% and 17%, to a high value of up to 100%, and vice versa. By using this system, extreme athletes and intensive athletes can prepare optimally for impending contests using altitude training units in the environment that is close to virtual reality. Near-reality training under low-oxygen conditions, for less-intensive and recreational athletes, aims more at increasing personal performance and an individual level of physical conditioning. Especially, expensive and time-consuming flights and stays in high mountain regions can be dispensed with. Moreover, substantially more-efficient training is possible, since the system is available 24 hours a day and is logistically easily attainable.

In the wellness field, this system can for instance combine an aroma application with passive altitude training and oxygen therapy, in a virtual three-dimensional environment.

In such an environment, a combination of stress relief and improvement in personal performance of this kind can be attained along with strengthening of the immune system. In the field of medicine, the system can be used for aroma application, altitude training, and/or oxygen therapy in a three-dimensional environment, in which the four senses, vision, touch, smell and hearing, are stimulated. With the thus-attained mobilizing of the body's own defense system, an application is conceivable for persons with diseases such as cancer, allergies, and metabolic diseases.

The technique of three-dimensional display also offers the possibility of favorably affecting psychological disease courses especially, such as anxieties in autoimmune system diseases, by means of the effect of images and noises.

1. A system for displaying a virtual environment comprising fitness equipment, a computer system having at least one control computer and a user surface;
a three-dimensional visual display, in which computers for image calculation for the right and left eyes are connected to the control computer via a network, generated signals provide stereo projection for generating a three-dimensional display on a screen, and a visual display unit reproduces an image with a viewing angle of 180° or more than 180°;
at least one acoustic output and/or recording means, and means for generating wind, temperature, and/or odor.

2. The system as defined by claim 1, comprising an implement for stimulating the sense of touch and/or for varying the composition of the breathing air.

3. The system as defined by claim 1 wherein the components are connected to one another and controlled via a computer system.

4. The system as defined by claim 1 wherein the generated signals are forwarded to a helmet, with LCDs for generating a virtual environment.

5. The system as defined by claim 1 wherein the control computer is connected to one or more input units having at least six degrees of freedom for determining the position and orientation, and the input units are equipped selectively with one or more keys.

6. The system as defined by claim 1 wherein isometric, isotonic and/or elastic input units are connected to the control computer.

7. The system as defined by claim 1 wherein with the input units, viewing motion detection, body motion detection, head motion detection, and/or position determination is effected.

8. The system as defined by claim 1 wherein with the input units, gestures, facial expressions, and/or speech is detected.

9. The system as defined by claim 1 wherein a head tracker is an input unit.

10. The system as defined by claim 1 wherein the visual display unit reproduces a still picture, a moving or nonmoving object, a computer graphic, and/or two- and/or three-dimensional moving pictures or films.

11. The system as defined by claim 1 wherein the visual display unit reproduces moving and/or still pictures taken by the user.

12. The system as defined by claim 1 wherein a rowing system, bicycle, or treadmill, for instance, is the fitness equipment.

13. The system as defined by claim 1 wherein performance data are detected and medical variables of the user are recorded.

14. The system as defined by claim 1 wherein the acoustic output unit reproduces music instruments, human voices, ambient noises, animal sounds, wind, rain, waterfalls, thunder, and/or noises of vehicle motors, shots, pumps, explosions, and/or excavation work.

15. The system as defined by claim 1 wherein wind, temperature, odor, and/or humidity are adapted to the displayed situation in virtual reality.

16. The system as defined by claim 1 wherein via a communications unit, directions and/or instructions from outside the system are given to the user.

17. The system as defined by claim 1 wherein the user can communicate with a person outside the system via a communications unit.

18. The system as defined by claim 1 wherein the user can vary the oxygen content within a few seconds from a low value, in the range between 9% and 17%, to a high value of up to 100%, and vice versa.

19. The system as defined by claim 1 wherein a cell analyzer, a device for flow cytometry, is connected to the computer system.

20. (canceled)

21. (canceled)

22. (canceled)

23. (canceled)

24. (canceled)

25. The system as defined by claim 19 wherein the cell analyzer comprises a device for flow cytometry.
